(19) United States
(12) Patent Application Publication
(10) Pub. No.: US 2025/0358405 A1
(43) Pub. Date: Nov. 20, 2025

(54) METHOD AND APPARATUS FOR VIDEO CODING USING VIRTUAL REFERENCE LINE

(71) Applicants: HYUNDAI MOTOR COMPANY, SEOUL (KR); KIA CORPORATION, SEOUL (KR); DIGITALINSIGHTS INC., SEOUL (KR)

(72) Inventors: Yong Jo Ahn, Seoul (KR); Jong Seok Lee, Seoul (KR); Jin Heo, Yongin-si (KR); Seung Wook Park, Yongin-si (KR)

(73) Assignees: HYUNDAI MOTOR COMPANY, SEOUL (KR); KIA CORPORATION, SEOUL (KR); DIGITALINSIGHTS INC., SEOUL (KR)

(21) Appl. No.: 18/865,850

(22) PCT Filed: May 2, 2023
(86) PCT No.: PCT/KR2023/005949

§ 371 Date: Nov. 14, 2024

(30) Foreign Application Priority Data
May 16, 2022 (KR) 10-2022-0059418
Apr. 27, 2023 (KR) 10-2023-0055538

(51) Int. Cl. H04N 19/11; H04N 19/105; H04N 19/174; H04N 19/176

(52) U.S. Cl. CPC H04N 19/11; H04N 19/105; H04N 19/174; H04N 19/176

(57) ABSTRACT

A method and an apparatus are disclosed for video coding using a virtual reference line. In the disclosed embodiments, a video decoding device decodes a virtual reference line usage flag and a reference mode index. When the virtual reference line usage flag is true, the video decoding device generates a reference mode list and derives an intra prediction mode of the current block from the reference mode list by using the reference mode index. In addition, the video decoding device generates the virtual reference line from a plurality of preset reference lines based on the virtual reference line usage flag and generates a prediction block of the current block using the virtual reference line based on the intra prediction mode.

### TECHNICAL FIELD

The present disclosure relates to a method and an apparatus device using a virtual reference line.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

Intra prediction predicts pixel values of a current block to be encoded using pixel information within the same picture. In the case of intra prediction, one of the most suitable intra prediction modes is selected according to characteristics of an image, and then the current block is encoded using the same. An encoder selects one of a plurality of intra prediction modes and encodes the current block by using the selected mode. Thereafter, the encoder may transmit information on the mode to a decoder.

HEVC technology uses a total of 35 intra prediction modes, including 33 directional modes (angular modes) and two non-directional modes (non-angular modes), for intra prediction. However, as the spatial resolution of images has increased from 720×480 to 2048×1024 or 8192×4096, the size of the prediction block unit has also increased, and accordingly, the need to add more diverse intra prediction modes has increased. As illustrated in FIG. 3A, the VVC technique may utilize prediction directions more diversely than in the related art by using 67 prediction modes more classified for intra prediction.

Meanwhile, since a predictor is generated based on the neighboring pixels of the current block in intra prediction, the performance of the intra prediction technique is related to the appropriate selection of reference pixels. In this regard, in addition to the method of obtaining reference pixels in a more accurate direction by securing the diversity of prediction modes as described above, a method of increasing the number of available candidate pixel lines may be considered. As the related art corresponding to the latter, there is multiple reference line (MRL) or multiple reference line prediction (MRLP). When the current block is predicted, the MRL technique may utilize not only the reference pixel line (hereinafter, ‘reference line’) adjacent to the current block, but also the pixels within a pixel line that exists thereafter. However, MRL has a problem in that only one of the plurality of candidate pixel lines is considered as a reference line. Therefore, in order to improve video encoding efficiency and image quality, a method of efficiently utilizing pixel lines needs to be considered.

### DISCLOSURE

### Technical Problem

The present disclosure seeks to provide a video coding method and an apparatus for generating a single virtual reference line by combining a plurality of pixel rows and pixel columns with high spatial similarity, in addition to a method of selecting an optimal reference line among a plurality of pixel rows and pixel columns with high spatial similarity in intra-predicting a current block using multiple pixel lines. The video coding method and the apparatus generate a prediction block by using the generated virtual reference line.

### Technical Solution

At least one aspect of the present disclosure provides a method of reconstructing a current block, performed by a video decoding device. The method includes decoding a virtual reference line usage flag and a reference mode index from a bitstream. Here, the virtual reference line usage flag indicates whether to use a virtual reference line for intra prediction of the current block. The method also includes generating a reference mode list based on the virtual reference line usage flag. The method also includes deriving an intra prediction mode of the current block from the reference mode list by using the reference mode index. The method also includes generating a first reference line or the virtual reference line from a plurality of preset reference lines based on the virtual reference line usage flag.

Another aspect of the present disclosure provides a method of predicting a current block, performed by a video decoding device. The method includes determining a first reference line from a plurality of preset reference lines. The method also includes generating a virtual reference line from the plurality of preset reference lines. The method also includes generating a reference mode list based on whether the first reference line or the virtual reference line is used. The method also includes determining an intra prediction mode of the current block from the reference mode list. The method also includes generating a first prediction block of the current block using the first reference line based on the intra prediction mode. The method also includes generating a second prediction block of the current block using the virtual reference line based on the intra prediction mode.

Yet another aspect of the present disclosure provides a computer-readable recording medium storing a bitstream generated by a video encoding method. The video encoding method includes determining a first reference line from a plurality of preset reference lines. The video encoding method also includes generating a virtual reference line from the plurality of preset reference lines. The video encoding method also includes generating a reference mode list based on whether the first reference line or the virtual reference line is used. The video encoding method also includes determining an intra prediction mode of a current block from the reference mode list. The video encoding method also includes generating a first prediction block of the current block using the first reference line based on the intra prediction mode. The video encoding method also includes generating a second prediction block of the current block using the virtual reference line based on the intra prediction mode.

### Advantageous Effects

As described above, the present disclosure provides a video coding method and an apparatus that combine a plurality of pixel rows and pixel columns with high spatial similarity to generate one virtual reference line. The video coding method and the apparatus generate a prediction block using the generated virtual reference line in intra-predicting a current block using multiple pixel lines. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating pixels used in most probable mode (MPM) configuration.

FIG. 7 is a diagram illustrating reference lines of multiple reference line (MRL) technology.

FIG. 8 is a diagram illustrating a current block and a reference line for intra prediction.

FIG. 9 is a diagram illustrating intra prediction using multiple reference lines.

FIG. 10 is a diagram illustrating intra prediction using a virtual reference line according to an embodiment of the present disclosure.

FIG. 11 is a block diagram conceptually illustrating an intra predictor according to an embodiment of the present disclosure.

FIG. 12 is a block diagram conceptually illustrating a reference sample composer.

FIG. 13 is a block diagram conceptually illustrating a reference sample composer according to an embodiment of the present disclosure.

FIG. 14 is a diagram illustrating reference sample padding according to an embodiment of the present disclosure.

FIG. 15 is a diagram illustrating generation of an MPM list according to an embodiment of the present disclosure.

FIG. 16 is a flowchart illustrating a method for a video encoding device to predict a current block according to an embodiment of the present disclosure.

FIG. 17 is a flowchart illustrating a method for a video decoding device to restore a current block according to an embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

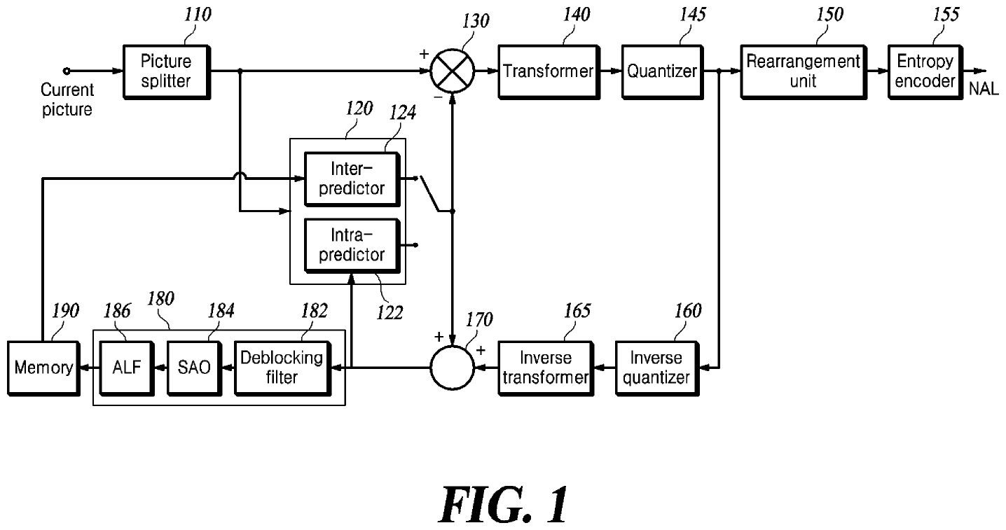

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

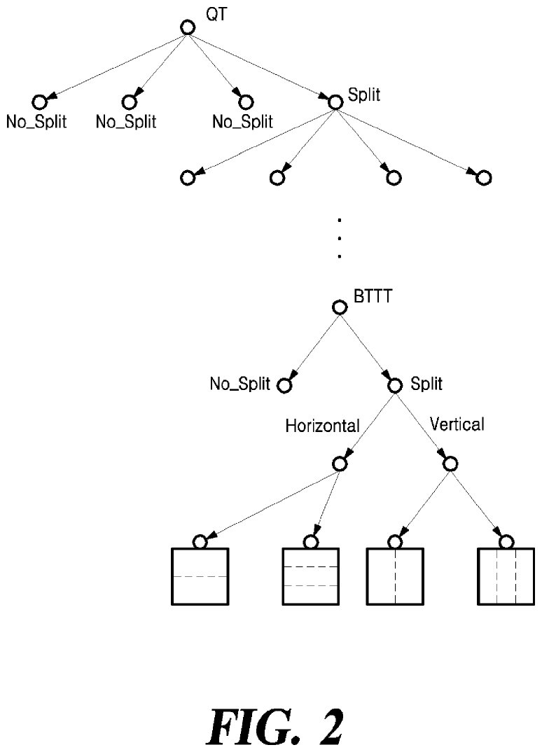

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

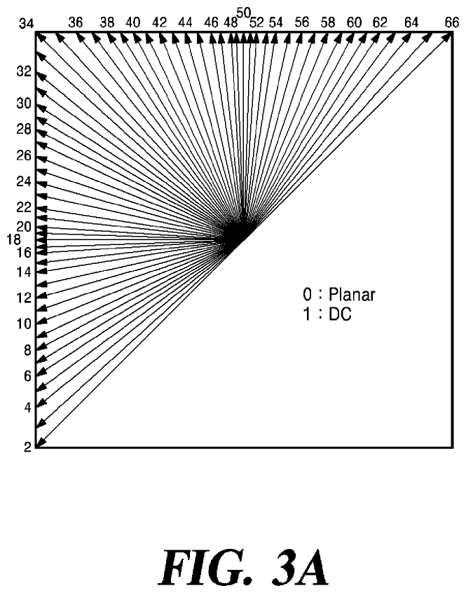

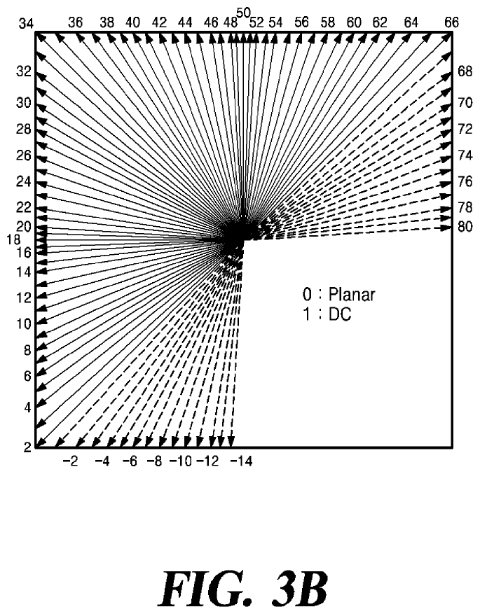

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

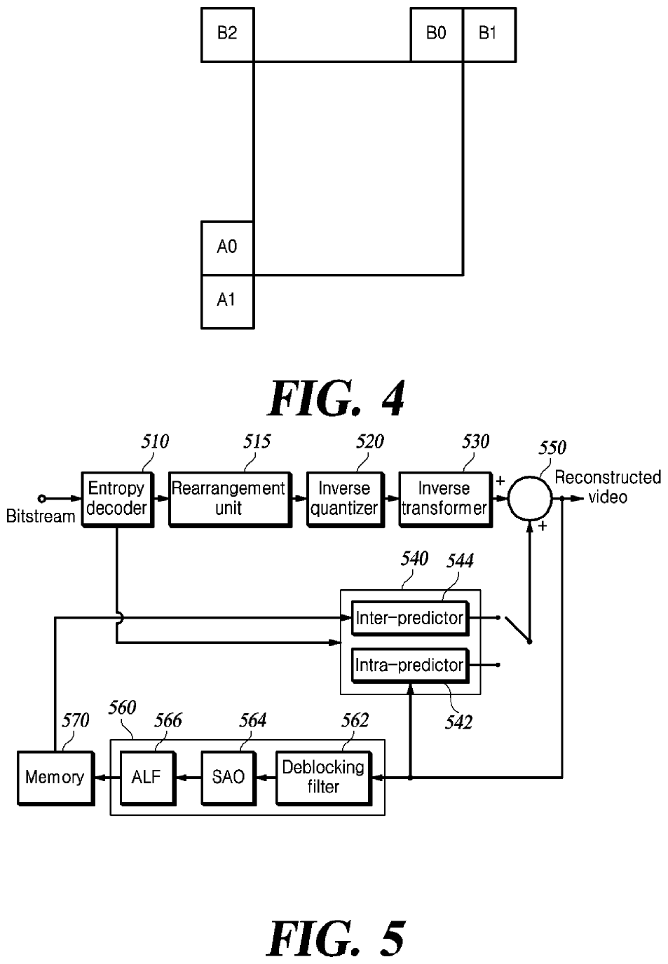

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform index or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that generates a single virtual reference line by combining a plurality of pixel rows and pixel columns with high spatial similarity and generate a prediction block using the generated virtual reference line, in intra-predicting a current block using multiple pixel lines.

The following embodiments may be performed by the intra predictor 122 in the video encoding device. The following embodiments may also be performed by the intra predictor 542 in the video decoding device.

The video encoding device in the prediction of the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the prediction of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. MPM and MRL

When a predictor is generated using one of the 67 intra prediction modes (IPMs), the video encoding device signals a prediction mode using the MPM to efficiently transmit prediction mode information. When the MPM mode is applied, the video encoding device may transmit a flag indicating whether to use the MPM list to the video decoding device. When the flag indicating whether to use the MPM list does not exist, the flag is inferred to be 1.

The MPM utilizes the property that the prediction modes of neighboring blocks are likely to be similar to each other when blocks are encoded in an intra prediction mode. When the MPM mode is used, six MPM candidates may be selected based on the prediction modes of the neighboring blocks of the current block. The set of six MPM candidates configured in this manner is called an MPM list. If the intra prediction mode of the current block is included in the MPM list, the video encoding device signals an MPM index indicating the intra prediction mode of the current block among the candidates included in the MPM list. Meanwhile, if the intra prediction mode of the current block is not included in the six MPM candidates, the video encoding device configures an MPM remainder by excluding six MPM candidates from 67 IPMs and then encodes the intra prediction mode based on the MPM remainder.

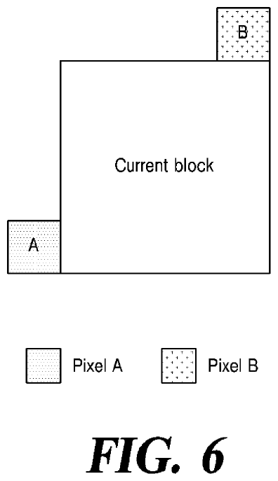

As in the example of FIG. 6, for blocks including pixel A located on the left of a bottom left pixel of the current block and pixel B located above a top right pixel, the prediction mode of each block is defined as modeA (hereinafter, ‘left mode’) and modeB (hereinafter, ‘top mode’). Based on modeA and modeB, 6 MPM candidates may be selected to generate an MPM list. If the current block is located on the boundary of a CTU, tile, slice, sub-picture, picture, or the like, and pixel A or pixel B is not available, the prediction mode of the block including the corresponding pixel is considered as planar.

First, if modeA and modeB are the same and modeA is greater than INTRA_DC (i.e., in the case of a directional prediction mode), {Planar, left mode, left mode−1, left mode+1, left mode−2, left mode+2} are selected as MPM candidates.

In addition, if modeA and modeB are not the same and modeA and modeB are greater than INTRA_DC (i.e., in the case of directional prediction mode), {Planar, left mode, top mode} is first added to the MPM list. Thereafter, different prediction modes may be added to the MPM list depending on the range of a difference value between the left mode and the top mode.

In addition, if modeA and modeB are not the same and modeA or modeB is greater than INTRA_DC (i.e., in the case of directional prediction mode), {Planar, maxAB, maxAB−1, maxAB+1, maxAB−2, maxAB+2} are selected as MPM candidates. Here, maxAB is defined as Max(modeA, modeB).

The multiple reference line (MRL) technology may use not only the reference line adjacent to the current block but also the pixels that exist further away as reference pixels, when the current block is predicted based on the intra prediction technology. Here, pixels at the same distance from the current block are grouped and named as a reference line. The MRL technology performs intra prediction of the current block by using pixels located on a selected reference line.

The video encoding device signals a reference line index intra_luma ref_idx to the video decoding device to indicate the reference line used in performing intra prediction. Here, bit alposition for each index may be expressed as in Table 1.

TABLE 1

| intra_luma_ref_idx | Bit allocation |
|---|---|
| 0 | 0 |
| 1 | 10 |
| 2 | 11 |

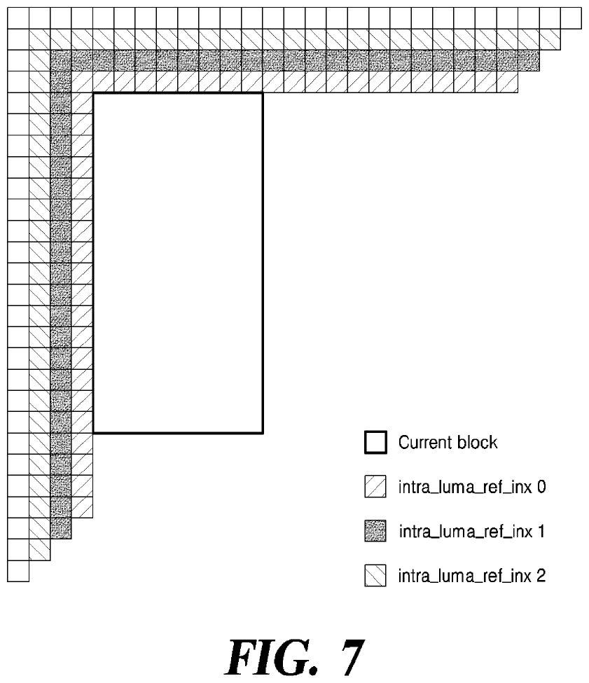

The video encoding device may consider whether to use an additional reference line by applying MRL to the prediction modes signaled according to MPM except Planar among the intra prediction modes. The reference line indicated by each intra luma_ref_idx is as shown in the example of FIG. 7. In the VVC technology, the video encoding device selects one of three reference lines that are close to the current block and uses the selected reference line for intra prediction of the current block. However, MRL has a problem in that only one of the plurality of candidate pixel lines is considered as a reference line. Hereinafter, a method for efficiently utilizing pixel lines to solve this problem is described.

The following embodiments are described based on the intra predictor 542 in the video decoding device, but may also be similarly applied to the intra predictor 122 of the video encoding device.

### II. Intra Prediction Using a Virtual Reference Line

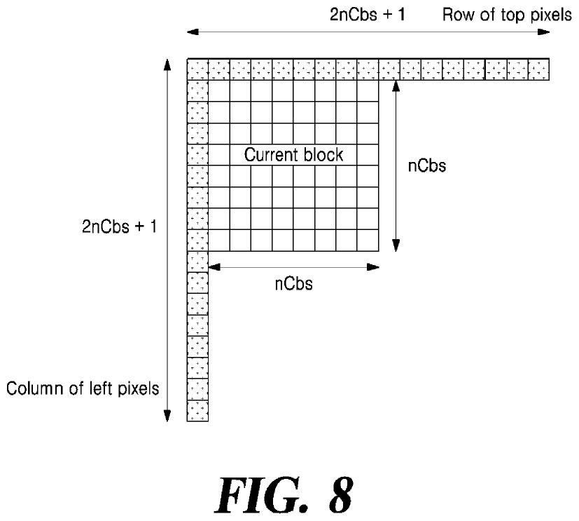

FIG. 8 is a diagram illustrating a current block and a reference line for intra prediction.

As in the example of FIG. 8, in the existing intra prediction, the intra predictor 542 designates the top pixel row and the left pixel column spatially adjacent to the current block as the reference line in order to generate an intra predictor of the current block. Thereafter, the intra predictor 542 may perform intra prediction using the corresponding reference line according to the directional prediction mode, DC, Planar mode, and the like, as shown in Table 3a.

As in the example of FIG. 8, the reference line for intra prediction is the pixel rows and pixel columns spatially adjacent to the current block. When the current block has a width of nCbs and a height of nCbs, the pixel rows and pixel columns may include top samples with a width of 2nCbs+1 and left samples with a height of 2nCbs+1, respectively. However, including overlapping reference samples at the top left, a reference line having a size of 4nCbs+1 may be configured.

In the above, a case in which the shape of the current block is a square is described, but the present disclosure is not limited thereto. In other words, even if the current block is a rectangle, the sizes of the pixel rows and pixel columns to be referenced may be set similarly.

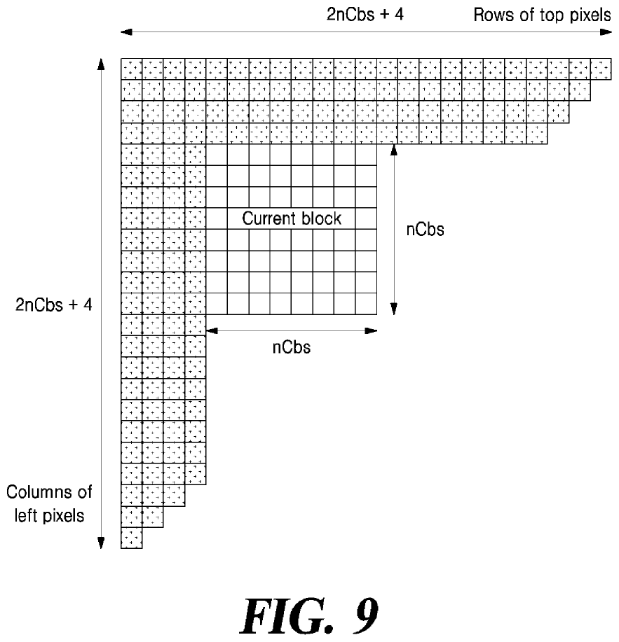

FIG. 9 is a diagram illustrating intra prediction using multiple reference lines.

Unlike the existing intra prediction illustrated in FIG. 8, in the intra prediction technology using multiple reference lines, as illustrated in FIG. 9, the intra predictor 542 selects one of a plurality of reference lines and then refers to the selected reference line. Here, the number and range of the plurality of reference lines to be selected may be previously set. In the example of FIG. 9, the number of reference lines is 4.

Recently, research has been actively conducted to increase the number of reference lines and selectively use one reference line among more diverse pixel lines. In addition to the technique of using one of a plurality of reference lines, in the present implementation example, a method of generating a virtual reference line based on two or more reference lines selected from a plurality of reference lines and performing intra prediction of the current block using the generated virtual reference line is described.

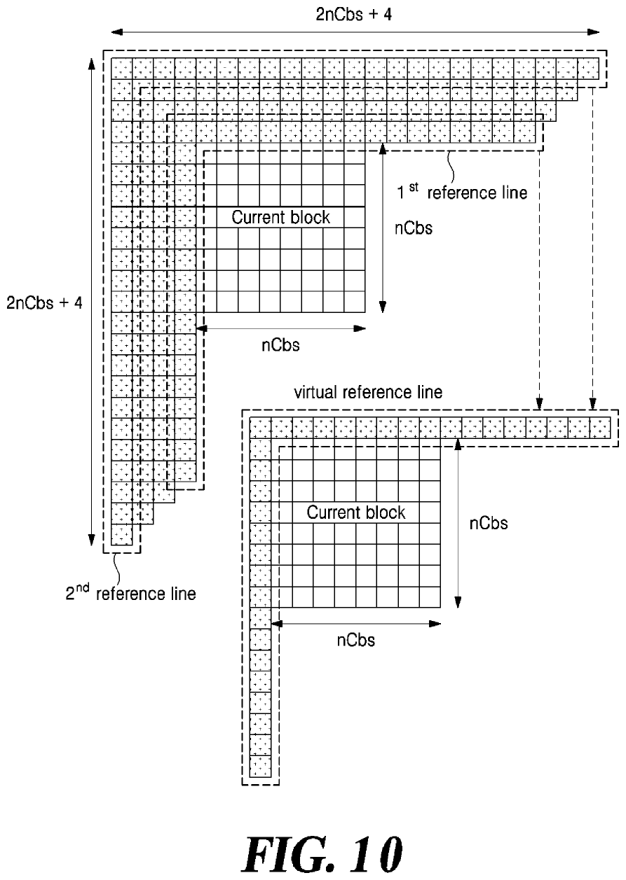

FIG. 10 is a diagram illustrating intra prediction using a virtual reference line according to an embodiment of the present disclosure.

As in the example of FIG. 9, in the intra prediction technique referencing multiple reference lines, the intra predictor 542 selects one of the plurality of reference lines and then refers to the selected reference line. In this regard, the example of FIG. 10 conceptually shows the generation of a virtual reference line used in intra prediction according to the present disclosure. In other words, for intra prediction using a virtual reference line according to the present disclosure, the intra predictor 542 selects two or more reference lines from the plurality of reference lines and then generates one virtual reference line by applying an operation, such as an average or a weighted sum to the corresponding reference lines. Thereafter, the intra predictor 542 may generate an intra prediction block using the virtual reference line. In the example of FIG. 10, one virtual reference line is generated using a first reference line and a fourth reference line as a first reference line and a second reference line. In addition, the operation for generating the virtual reference line may be set in advance according to the agreement between the video encoding device and the video decoding device.

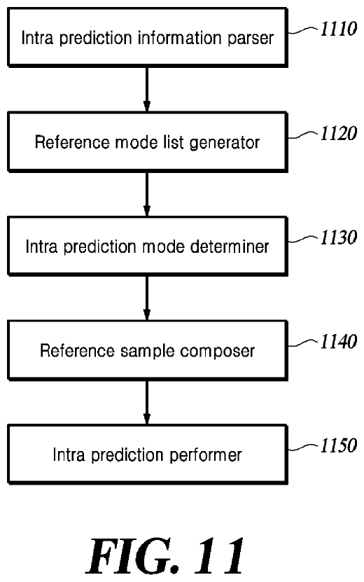

FIG. 11 is a block diagram conceptually illustrating an intra predictor according to an embodiment of the present disclosure.

The intra predictor 542 of the video decoding device illustrated in FIG. 5 may include components, such as the example of FIG. 11 for intra prediction using a virtual reference line. The intra predictor 542 may include all or some of an intra prediction information parser 1110, a reference mode list generator 1120, an intra prediction mode determiner 1130, a reference sample composer 1140, and an intra prediction performer 1150. Meanwhile, the intra predictor 122 of the video encoding device illustrated in FIG. 1 may also include components, such as those of the example of FIG. 11 for intra prediction using a virtual reference line.

The intra prediction information parser 1110 acquires information related to intra prediction from the bitstream. The information on intra prediction may include an index on an intra prediction mode of the current block, whether to use a reference mode list, whether to perform intra prediction using a virtual reference line, etc.

First, whether to use a reference mode list may be indicated by a reference mode usage flag, which is a 1-bit flag. For example, when the reference mode usage flag is true, a reference mode list is used, and when the reference mode usage flag is false, the reference mode list is not used. In addition, when the reference mode list is used, the information of the intra prediction includes an index (hereinafter, ‘reference mode index’) indicating one prediction mode on the reference mode list. In short, the reference mode index indicates one of candidates in the reference mode list. Meanwhile, when the reference mode list is not used, the information of the intra prediction mode may include information indicating one of the remaining modes excluding the modes included in the reference mode list. Here, the information indicating one of the remaining modes may be an index or an intra prediction mode. Hereinafter, for convenience, the information indicating one of the remaining modes is referred to as a surplus mode index. Therefore, in the information of the intra prediction, the index regarding the intra prediction mode of the current block may be a reference mode index or the surplus mode index.

Whether to perform intra prediction using a virtual reference line may also be indicated by a virtual reference line usage flag, which is a 1-bit flag. For example, if the virtual reference line usage flag is true, intra prediction may be performed using the virtual reference line, and if the virtual reference line usage flag is false, intra prediction may be performed using the reference line.

The reference mode list generator 1120 generates a reference mode list based on the information of the intra prediction mode acquired from the intra prediction information parser 1110. For example, if the use of the reference list is indicated, the reference mode list generator 1120 may generate a reference mode list. Meanwhile, in the case of intra prediction using a virtual reference line, the reference mode list may be configured to be limited to some of the intra prediction modes available for the current block. This is because, in the case of intra prediction using a virtual reference line, pixels generated by primarily applying weighting or averaging between existing spatially adjacent reference pixels are re-referenced. In other words, in the case of intra prediction using a virtual reference line, the directionality of intra prediction may be limited.

The intra prediction mode determiner 1130 determines the intra prediction mode of the current block by using the intra prediction mode information acquired from the intra prediction information parser 1110 and the reference mode list acquired from the reference mode list generator 1120. If the intra prediction mode of the current block is included in the reference mode list, the intra prediction mode of the current block is determined from the reference mode list by using the reference mode index. Meanwhile, if the intra prediction mode of the current block is not included in the reference mode list, the intra prediction mode may be determined by using the surplus mode index acquired from the intra prediction information parser 1110.

For example, when the intra prediction mode using a virtual reference line is utilized, there may be a limitation that intra prediction has to be performed using only a reference mode included in the reference mode list. Therefore, in the case of the intra prediction mode using a virtual reference line, information indicating whether to use the reference mode list, i.e., a reference mode usage flag, may not be signaled. In other words, intra prediction may be performed implicitly using one of the intra prediction modes included in the reference mode list. When the reference mode usage flag is not signaled, the reference mode usage flag may be inferred to be true, and thus, the use of the reference mode list may be indicated.

The reference sample composer 1140 composes a reference line based on the intra prediction mode determined by the intra prediction mode determiner 1130. Here, in order to improve prediction performance, the reference sample composer 1140 may perform reference pixel padding or reference pixel filtering on pixels spatially adjacent to the current block.

Meanwhile, in the case of intra prediction using a virtual reference line, the reference sample composer 1140 may generate one virtual reference line by combining one or more reference lines. In other words, the reference sample composer 1140 may perform an arithmetic operation between pixels at corresponding positions for one reference line (i.e., the ‘first reference line’) and another reference line (i.e., the ‘second reference line’) to generate one pixel having a result value of the arithmetic operation. Here, the operation between pixels may include an average, a weighted sum, or the like.

For example, in the case of using an average operation, the reference sample composer 1140 may perform an average operation between pixels at corresponding positions for the first reference line and the second reference line to generate an average pixel value, and then compose a virtual reference line by using the generated average pixel value.

The intra prediction performer 1140 may generate a predictor of the current block by using the reference line and the intra prediction mode. Meanwhile, in the case of intra prediction using a virtual reference line, the intra prediction performer 1140 may generate a predictor of the current block by using the virtual reference line and the intra prediction mode. The intra prediction performer 1140 may configure prediction samples of the current block by using the reference line or the virtual reference line based on the intra prediction mode in order to generate a prediction block of the current block.

Meanwhile, the adder 550 may generate a reconstructed block of the current block by combining the predictor acquired from the reference sample composer 1140 and a residual signal acquired from the inverse transformer 530.

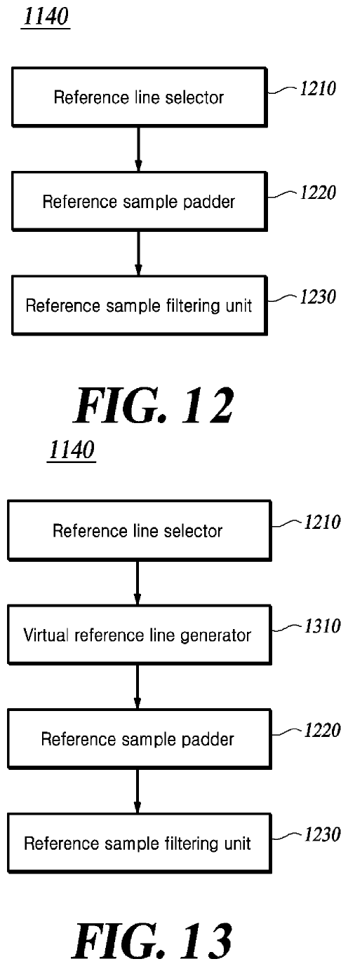

FIG. 12 is a block diagram conceptually representing a reference sample composer.

As an example, in order to generate one reference line among multiple reference lines, the reference sample composer 1140 may include all or some of the reference line selector 1210, a reference sample padder 1220, and a reference sample filtering unit 1230.

The reference line selector 1210 selects one reference line among a plurality of reference lines. However, the operation of the reference line selector 1210 may be performed only in the case of intra prediction using multiple reference lines. Here, the multiple reference lines to be selected may be previously set. The reference line selector 1210 parses information for selecting one reference line among multiple reference lines from the bitstream. The information for selecting one reference line may be an index indicating one reference line among one or more pixel lines. After selecting one reference line using the above-described index, the reference line selector 1210 may perform padding or filtering of the reference sample.

The reference sample padder 1220 may pad pixels existing in the reference sample line. The reference sample padder 1220 determines an unreconstructed pixel or an unavailable pixel among the reconstructed pixels spatially adjacent to the current block. Thereafter, the reference sample padder 1220 generates pixel values at all positions referenced by the current block using the reconstructed pixels or available pixels.

The reference sample filtering unit 1230 performs filtering on reference pixels having integer-pel accuracy of the current block according to the intra prediction mode of the current block. The reference sample filtering unit 1230 may generate reference pixels having fractional-pel accuracy by applying filtering to reference pixels having integer accuracy. Here, a predefined interpolation filter may be used to generate reference pixels having fractional accuracy.

FIG. 13 is a block diagram conceptually illustrating a reference sample composer according to an embodiment of the present disclosure.

As an example, in order to generate a virtual reference line, the reference sample composer 1140 may further include a virtual reference line generator 1310 in addition to the reference line selector 1210, the reference sample padder 1220, and the reference sample filtering unit 1230.

The reference line selector 1210 selects one reference line among a plurality of reference lines. However, the operation of the reference line selector 1210 may be performed only in the case of intra prediction using multiple reference lines. Here, the multiple reference lines to be selected may be previously set. Meanwhile, in the case of intra prediction using a virtual reference line, the reference line selected by the reference line selector 1210 may be used as a first reference line of the current block. The reference line selector 1210 parses information for selecting a first reference line among the plurality of reference lines from a bitstream. Information for selecting the first reference line may be an index indicating one of the reference lines among one or more pixel lines. Hereinafter, the index indicating the first reference line is referred to as a first reference line index.

After selecting the first reference line using the above-described index, the reference line selector 1210 determines whether the current block is a block that uses intra prediction using a virtual reference line. Here, a virtual reference line usage flag, which is information indicating whether intra prediction using a virtual reference line is performed, may be used.

If the above-described virtual reference line usage flag is true and the current block is a block that performs intra prediction using a virtual reference line, the reference line selector 1210 selects the second reference line and the virtual reference line generator 1310 generates a virtual reference line by using the first reference line and the second reference line. Meanwhile, if the above-described virtual reference line usage flag is false and the current block is not a block that performs intra prediction using a virtual reference line, the operation of the reference line selector 1210 selecting the second reference line and the operation of the virtual reference line generator 1310 may be omitted.

In order to select the second reference line, the reference line selector 1210 additionally selects one reference line among a plurality of reference lines. The reference line selector 1210 parses information for selecting the second reference line among the plurality of reference lines from the bitstream. The information for additionally selecting the reference line may be an index indicating one reference line among one or more pixel lines. In other words, the index indicating the second reference line may indicate one of the remaining available reference line candidates excluding the first reference line. Hereinafter, the index indicating the second reference line is referred to as a second reference line index.

The virtual reference line generator 1310 generates a virtual reference line by combining the first reference line and the second reference line in the case of intra prediction using a virtual reference line. As described above, the virtual reference line generator 1310 may perform an arithmetic operation between pixels at corresponding positions for the first reference line and the second reference line to generate one pixel having a result value of the arithmetic operation. Here, the arithmetic operation between pixels may include an average, a weighted sum, or the like.

For example, in the case of using an average operation, the virtual reference line generator 1310 may perform an average operation between pixels at corresponding positions for the first reference line and the second reference line to generate an average pixel value and then may configure a virtual reference line using the generated average pixel value.

The reference sample padder 1220 may pad pixels existing in the reference sample line. The reference sample padder 1220 determines an unreconstructed pixel or an unavailable pixel among the reconstructed pixels spatially adjacent to the current block. Thereafter, the reference sample padder 1220 generates pixel values at all positions referenced by the current block using reconstructed pixels or available pixels.

However, in the case of intra prediction using a virtual reference line, un unreconstructed pixels or unavailable pixels may be removed during the process of the virtual reference line generator 1310 generating the virtual reference line. In this case, padding may be omitted for pixels at the corresponding positions.

The reference sample filtering unit 1230 performs filtering on a reference pixel having integer-pel accuracy of the current block according to the intra prediction mode of the current block. The reference sample filtering unit 1230 may generate reference pixels having fractional-pel accuracy by applying filtering to the reference pixels having integer-pel accuracy. Here, a predefined interpolation filter may be used to generate reference pixels having fractional accuracy.

However, in the case of intra prediction using a virtual reference line, since a filtering-like operation, such as a weighted sum or an average, occurs during the process of generating a virtual reference line by the virtual reference line generator 1310, filtering may not be performed. In other words, since a single virtual reference line is generated by combining the first reference line and the second reference line, the same effect as reference sample filtering may be determined to occur. In addition, in this case, the number of used intra prediction modes may also be reduced compared to general intra prediction.

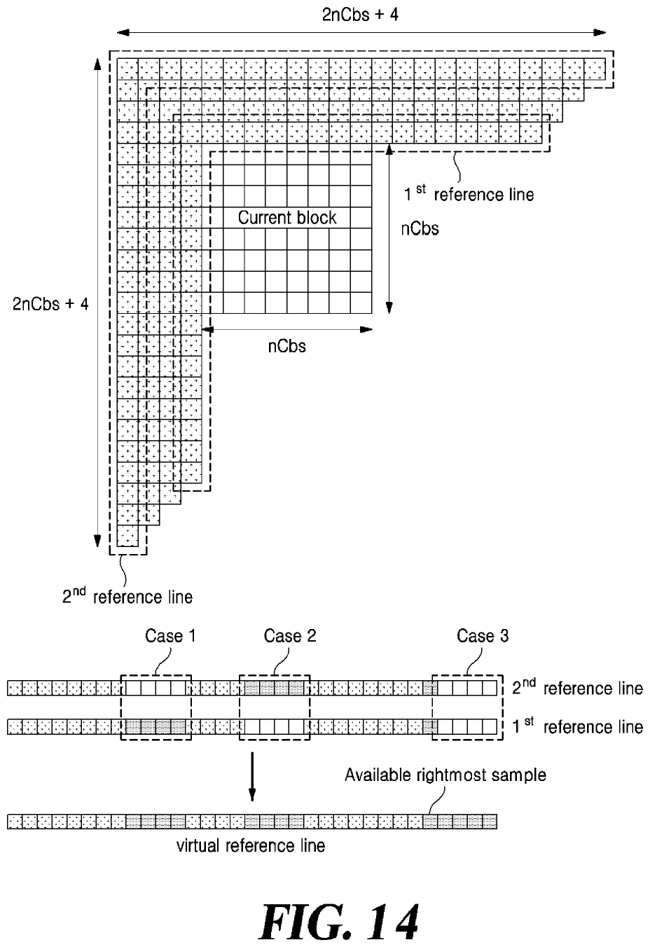

FIG. 14 is a diagram illustrating reference sample padding according to an embodiment of the present disclosure.

As in the example of FIG. 14, in the case of intra prediction using a virtual reference line, a single virtual reference line may be generated by combining the first reference line and the second reference line.

Here, the intra prediction technique using a virtual reference line according to the present disclosure may compose all pixels as available for reference by using reference sample padding for reference pixels that are unavailable among the reference pixels that constitute the first reference line and the second reference line.

As an example, as illustrated in FIG. 14, a case in which a single virtual reference line is configured by combining the first reference line and the second reference line is described. In other words, pixels of the virtual reference line may be generated by performing a weighted sum operation for each corresponding pixel position. Here, there may be a case (case 1) in which the reference pixel of the first reference line is available, but the reference pixels of the second reference line are unavailable. Alternatively, there may be a case (case 2) in which the reference pixel of the second reference line is available, but the corresponding reference pixel of the first reference line is not available. In other words, there are cases in which the reference pixel of one reference line is available, but the corresponding reference pixel of the other reference line is not available. For these two cases, the reference pixel of the virtual reference line may be generated by using the value of the available pixel among the two reference pixels as it is.

As another example, as in the example of FIG. 14, a case in which both the corresponding reference pixels of the two reference lines among the reference pixels constituting the first reference line and the second reference line are not available (case 3) is described. In this case, one virtual reference line may be generated by applying a weighted sum operation to the reference pixels of the first reference line and the second reference line, and reference pixels at unavailable positions may be generated by performing reference sample padding in the rightward direction using the available rightmost pixel.

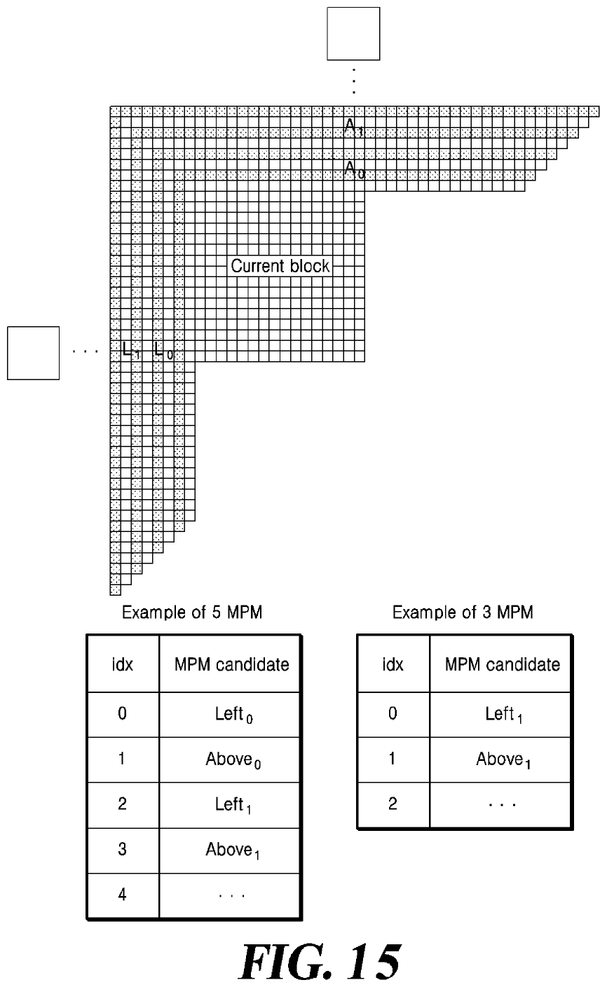

FIG. 15 is a diagram illustrating the generation of an MPM list according to an embodiment of the present disclosure.

The MPM list in the existing intra prediction may correspond to a reference mode list in the intra prediction using a virtual reference line according to the present disclosure. Therefore, the intra predictor 542 may generate a reference mode list according to a method of generating the existing MPM list.

In addition, as illustrated in FIG. 15, when the current block is decoded in the intra prediction mode using a virtual reference line, the intra predictor 542 may configure an MPM list (i.e., the reference mode list) to be different from the existing MPM list generating method. In addition, when the current block is decoded in the intra prediction mode using a virtual reference line, the size of the reference mode list may be different from the size of the existing MPM list.

As described above, the existing intra prediction technology configures an MPM list by applying a predefined rule to the intra prediction modes at predefined top and left positions that are spatially adjacent to the current block. In other words, the MPM list may be configured using the intra prediction modes of the adjacent top and left blocks and the prediction modes adjacent to the directionality of the corresponding intra prediction modes.

Meanwhile, the intra prediction technology using a virtual reference line according to the present disclosure may generate an intra prediction block by referring to a pixel line that is not spatially immediately adjacent. Therefore, the intra prediction technology using a virtual reference line may configure an MPM list (i.e., a reference mode list) using the intra prediction modes of the top and left blocks that are spatially adjacent to the current block and the intra prediction mode of a spatially non-adjacent block.

As an example, as in the example of FIG. 15, the intra predictor 542 may configure an MPM list by deriving the intra prediction modes of the spatially adjacent block and the non-adjacent block on the top or left predefined in 4×4 block units. Here, the above-described 4×4 block is a storage unit for storing the intra prediction mode, and the storage unit may have different sizes, such as an 8×8 block, a 2×2 block, or the like. In the example of FIG. 15, A₀ (Above₀) is a storage unit adjacent to the top, and A₁ (Above₁) is a storage unit non-adjacent to the top. In addition, L₀ (Left₀) is a storage unit adjacent to the left, and L₁ (Left₁) is a storage unit non-adjacent to the left.

In addition, when configuring the MPM list using the intra prediction mode of non-adjacent blocks, the intra predictor 542 may set the order of MPM candidates included in the MPM list based on the reference position including a pixel line selected to configure a virtual reference line. For example, in the case of configuring one virtual reference line using reference lines #5 and #12, the candidates of the MPM list may be configured in the order of the intra prediction mode of the left block non-adjacent to the current block at the reference line position #5, the intra prediction mode of the top block non-adjacent to the current block at the reference line position #5, the intra prediction mode of the left block non-adjacent to the current block at the reference line position #12, and the intra prediction mode of the top block non-adjacent to the current block at the reference line position #12. In other words, in order to configure an MPM list according to the present disclosure, the intra predictor 542 may refer to the intra prediction mode at the spatially non-adjacent block position. In addition, the intra predictor 542 may select a spatially non-adjacent block position based on the position of the reference line referenced by the current block.

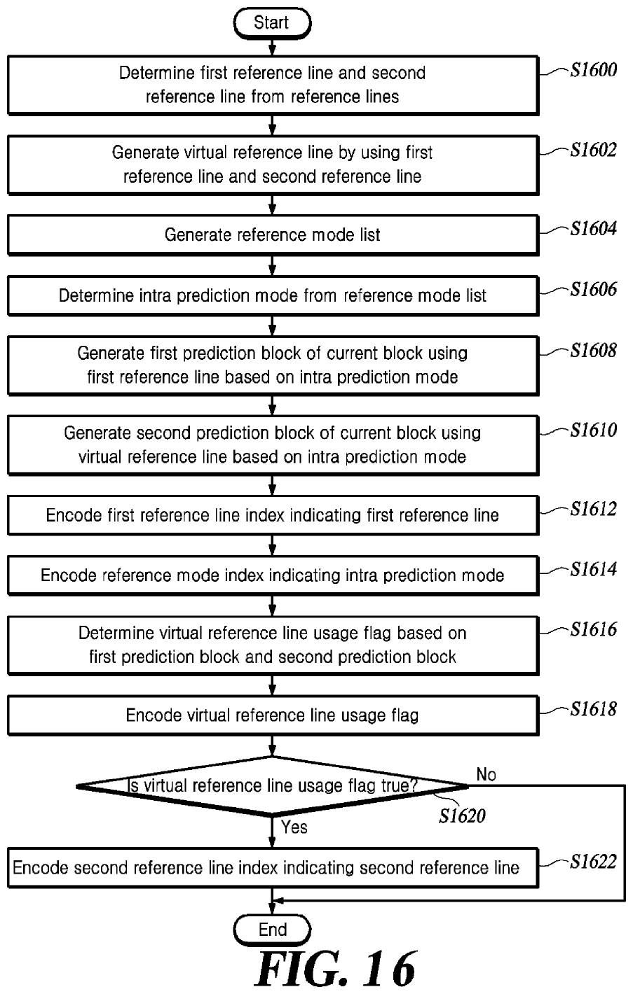

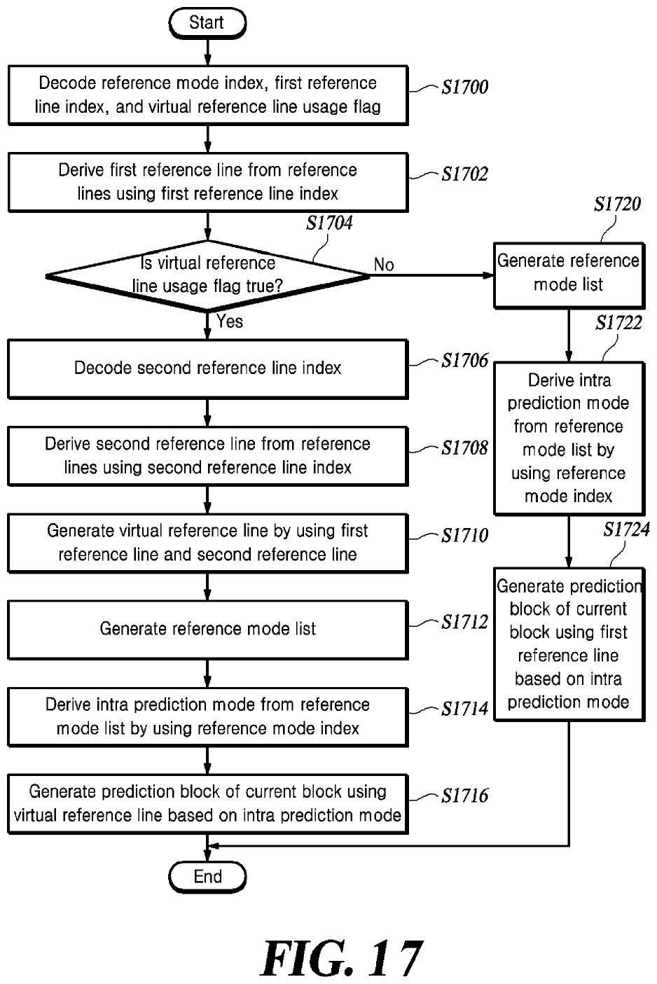

Hereinafter, a method for intra-predicting a current block based on multiple reference lines is described using the illustrations of FIGS. 16 and 17.

FIG. 16 is a flowchart illustrating a method for a video encoding device to predict a current block according to an embodiment of the present disclosure.

The video encoding device determines a first reference line and a second reference line from a plurality of reference lines (S1600). Here, the number and range of the plurality of reference lines to be selected may be preset according to an agreement between the video encoding device and the video decoding device. The second reference line may be one of the remaining available reference line candidates excluding the first reference line. Meanwhile, the first reference line and the second reference line may be determined in terms of rate distortion optimization.

The video encoding device generates a virtual reference line by using the first reference line and the second reference line (S1602).

In order to generate a virtual reference line, the video encoding device performs an arithmetic operation between pixels at corresponding positions for the first reference line and the second reference line to generate a pixel having a result value of the arithmetic operation. The arithmetic operation for generating the virtual reference line may be an average, a weighted sum, or the like. In addition, the operation for generating the virtual reference line may be set in advance according to an agreement between the video encoding device and the video decoding device.

The video encoding device generates a reference mode list depending on whether the first reference line or the virtual reference line is used (S1604).

In the case of using the first reference line, the video encoding device generates a reference mode list by using intra prediction modes of the top and left blocks spatially adjacent to the current block according to the method of configuring an existing MPM list.

Meanwhile, in the case of using a virtual reference line, the video encoding device may generate a reference mode list according to the method of configuring an existing MPM list. Alternatively, the video encoding device may generate a reference mode list by using the intra prediction mode of a spatially adjacent block and the intra prediction mode of a spatially non-adjacent block with respect to the current block.

The video encoding device determines the intra prediction mode of the current block from the reference mode list (S1606). Here, the intra prediction mode may be determined in terms of rate distortion optimization.

The video encoding device generates a first prediction block of the current block using a first reference line based on the intra prediction mode of the current block (S1608).

The video encoding device generates a second prediction block of the current block using a virtual reference line based on the intra prediction mode of the current block (S1610).

The video encoding device encodes the first reference line index indicating the first reference line (S1612).

The video encoding device encodes the reference mode index indicating the intra prediction mode of the current block in the reference mode list (S1614).

The video encoding device determines a virtual reference line usage flag based on the first prediction block and the second prediction block (S1616). Here, the virtual reference line usage flag indicates whether to use the virtual reference line for intra prediction of the current block. Meanwhile, in terms of rate distortion optimization, the virtual reference line usage flag may be determined by checking the first prediction block and the second prediction block.

The video encoding device encodes the virtual reference line usage flag (S1618).

The video encoding device checks the virtual reference line usage flag (S1620).

If the virtual reference line usage flag is true (Yes in S1620), the video encoding device encodes a second reference line index indicating the second reference line (S1622).

FIG. 17 is a flowchart illustrating a method for a video decoding device to reconstruct a current block according to an embodiment of the present disclosure.

The video decoding device decodes a reference mode index, a first reference line index, and a virtual reference line usage flag from a bitstream (S1700). Here, the virtual reference line usage flag indicates whether to use a virtual reference line for intra prediction of the current block.

The video decoding device derives a first reference line from a plurality of reference lines using the first reference line index (S1702). Here, the number and range of the plurality of reference lines to be selected may be previously set according to an agreement between the video encoding device and the video decoding device.

The video decoding device checks the virtual reference line usage flag (S1704).

First, if the virtual reference line usage flag is true (Yes in S1704), the video decoding device performs the following operations.

The video decoding device decodes the second reference line index (S1706). The second reference line index may indicate one of the remaining available reference line candidates excluding the first reference line.

The video decoding device derives the second reference line from a plurality of reference lines using the second reference line index (S1708).

The video decoding device generates a virtual reference line by using the first reference line and the second reference line (S1710).

In order to generate the virtual reference line, the video decoding device performs an arithmetic operation between pixels at corresponding positions for the first reference line and the second reference line to generate a pixel having a result value of the arithmetic operation. The arithmetic operation for generating the virtual reference line may be an average, a weighted sum, or the like. In addition, the arithmetic operation for generating a virtual reference line may be set in advance according to the agreement between the video encoding device and the video decoding device.

The video decoding device generates a reference mode list (S1712).

The video decoding device may generate the reference mode list by using intra prediction modes of top and left blocks spatially adjacent to the current block according to a method of configuring an existing MPM list. Alternatively, the video decoding device may generate the reference mode list by using intra prediction modes of blocks spatially adjacent to the current block and intra prediction modes of blocks spatially non-adjacent with respect to the current block.

The video decoding device derives an intra prediction mode of the current block from the reference mode list by using the reference mode index (S1714).

The video decoding device generates a prediction block of the current block using the virtual reference line based on the intra prediction mode (S1716).

Meanwhile, if the virtual reference line usage flag is false (No in S1704), the video decoding device may perform the following operations.

The video decoding device generates a reference mode list (S1720).

The video decoding device may generate the reference mode list by using intra prediction modes of top and left blocks spatially adjacent to the current block according to a method of configuring an existing MPM list.

The video decoding device derives an intra prediction mode of the current block from the reference mode list by using a reference mode index (S1722).

The video decoding device generates a prediction block of the current block using the first reference line based on the intra prediction mode (S1724).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

122: intra predictor
155: entropy encoder
510: entropy decoder
542: intra predictor
1110: intra prediction information parser
1120: reference mode list generator
1130 intra prediction mode determiner
1140: reference sample composer
1150: intra prediction performer

### CROSS-REFERENCE TO RELATED APPLICATIONS

This application claims priority to and the benefit of Korean Patent Application No. 10-2022-0059418 filed on May 16, 2022, and Korean Patent Application No. 10-2023-0055538, filed on Apr. 27, 2023, the entire contents of each of which are incorporated herein by reference.

1. A method of reconstructing a current block, performed by a video decoding device, the method comprising:
decoding a virtual reference line usage flag and a reference mode index from a bitstream, wherein the virtual reference line usage flag indicates whether to use a virtual reference line for intra prediction of the current block;
generating a reference mode list based on the virtual reference line usage flag;
deriving an intra prediction mode of the current block from the reference mode list by using the reference mode index; and
generating a first reference line or the virtual reference line from a plurality of preset reference lines based on the virtual reference line usage flag.

2. The method of claim 1, wherein generating the virtual reference line includes:
decoding the first reference line index;
deriving the first reference line from the plurality of reference lines using the first reference line index; and
checking the virtual reference line usage flag.

3. The method of claim 2, wherein, when the virtual reference line usage flag is true, generating the virtual reference line includes:
decoding a second reference line index;
deriving a second reference line from the plurality of reference lines using the second reference line index; and
generating the virtual reference line by using the first reference line and the second reference line.

4. The method of claim 3, further comprising:
generating a prediction block of the current block using the virtual reference line based on the intra prediction mode.

5. The method of claim 3, wherein generating the virtual reference line includes:
performing a preset arithmetic operation between pixels at corresponding positions for the first reference line and the second reference line to generate a pixel having a result value of the preset arithmetic operation.

6. The method of claim 2, wherein generating the virtual reference line includes:
when a reference pixel of one of the first reference line and the second reference line is available but a corresponding reference pixel of the other reference line is not available, generating a reference pixel of the virtual reference line by using a value of the available reference pixel.

7. The method of claim 3, wherein generating the virtual reference line includes:
when the corresponding reference pixels of the first reference line and the second reference line are all unavailable, perfoming reference sample padding in a rightward direction by using an available rightmost reference pixel in a virtual reference line generated based on the preset arithmetic operation.

8. The method of claim 2, further comprising:
when the virtual reference line usage flag is false, generating a prediction block of the current block using the first reference line according to the intra prediction mode.

9. The method of claim 2, wherein generating the reference mode list includes:
checking the virtual reference line usage flag,
wherein when the virtual reference line usage flag is true, generating the reference mode list further includes:
using an intra prediction mode of a spatially adjacent block and an intra prediction mode of a spatially non-adjacent block with respect to current block.

10. The method of claim 9, wherein generating the reference mode list includes:
setting an order of candidates included in the reference mode list based on a reference position including a reference line selected to compose the virtual reference line.

11. A method of predicting a current block, performed by a video decoding device, the method comprising:
determining a first reference line from a plurality of preset reference lines;
generating a virtual reference line from the plurality of preset reference lines;
generating a reference mode list based on whether the first reference line or the virtual reference line is used;
determining an intra prediction mode of the current block from the reference mode list;
generating a first prediction block of the current block using the first reference line based on the intra prediction mode; and
generating a second prediction block of the current block using the virtual reference line based on the intra prediction mode.

12. The method of claim 11, further comprising:
encoding a first reference line index indicating the first reference line; and
encoding a reference mode index indicating the intra prediction mode of the current block in the reference mode list.

13. The method of claim 11, wherein generating the virtual reference line includes:
deriving a second reference line from the plurality of reference lines; and
generating the virtual reference line using the first reference line and the second reference line.

14. The method of claim 11, further comprising:
determining a virtual reference line usage flag based on the first prediction block and the second prediction block, wherein the virtual reference line usage flag indicates whether to use the virtual reference line for intra prediction of the current block; and
encoding the virtual reference line usage flag.

15. The method of claim 14, further comprising:
checking the virtual reference line usage flag,
wherein, when the virtual reference line usage flag is true, the method further comprises:
encoding a second reference line index indicating the second reference line.

16. The method of claim 14, wherein generating the reference mode list includes:
when the virtual reference line is used, generating the reference mode list by using an intra prediction mode of a spatially adjacent block and an intra prediction mode of a spatially non-adjacent block with respect to the current block.

17. A computer-readable recording medium storing a bitstream generated by a video encoding method, the video encoding method comprising:
determining a first reference line from a plurality of preset reference lines;
generating a virtual reference line from the plurality of preset reference lines;
generating a reference mode list based on whether the first reference line or the virtual reference line is used;
determining an intra prediction mode of a current block from the reference mode list;
generating a first prediction block of the current block using the first reference line based on the intra prediction mode; and
generating a second prediction block of the current block using the virtual reference line based on the intra prediction mode.
